(19) United States
(12) Patent Application Publication
(10) Pub. No.: US 2014/0202147 A1
(43) Pub. Date: Jul. 24, 2014

(54) Heat Engine with High Efficiency Attributable to Temperature Responsive Equilibrium Reactions and Method for Optimization

(71) Applicant: Christopher Michael Woodsum, Bedford, NH (US)

(72) Inventor: Christopher Michael Woodsum, Bedford, NH (US)

(21) Appl. No.: 14/163,707

(22) Filed: Jan. 24, 2014

Related U.S. Application Data
(60) Provisional application No. 61/756,351, filed on Jan. 24, 2013.

(51) Int. Cl. F02G 1/043; F02G 1/047

(52) U.S. Cl. CPC F02G 1/043; F02G 1/047
USPC 60/517

(57) ABSTRACT

Heat engines perform a thermodynamic cycle, making use of working fluid which increases pressure and/or volume in response to temperature, resulting in the transformation of heat into useful work. The present invention makes use of a particular type of working fluid that undergoes one or more reversible chemical reactions in response to an increase in temperature, to increase the molar quantity of fluid, producing more useful work and higher thermal efficiency than similar, conventional engines. One embodiment takes the form of a Stirling engine, with a regenerative heat exchange process which recovers most of the energy required to cause the chemical dissociation, ensuring efficiency gain. A method for selecting the working fluid, useful temperature ranges for the engine, and other operating parameters is also claimed. Other types of embodiments may take the form of turbine engines, with one embodiment being a turbine engine that approximates an Ericsson cycle.

### CROSS-REFERENCE TO RELATED APPLICATIONS

This application claims priority under Section 119(e) to the U.S. Provisional Application No. 61/756,351, entitled, “Chemically Dissociating Working Fluid Engine and Method for Generating Power Without Natural Temperature Gradients”, filed Jan. 24, 2013, the contents of which are incorporated by reference herein in its entirety and for all purposes.

### FIELD OF THE INVENTION

The devices of the present disclosures are novel types of heat engines, to include turbines, which take advantage of chemically reacting working fluid components to significantly improve thermal efficiency. When operated under select conditions, determined by a described method for optimization, the stated engines are shown to have superior thermal efficiency and work output per mole of working fluid per cycle compared to conventional engines of the same class operating over the same temperature range. Particular emphasis is given to the Stirling engine embodiment, as the calculations involved in theoretically optimizing the thermal efficiency of this embodiment are relatively simple and demonstrate the principles of the present invention in an intuitive manner.

### BACKGROUND OF THE INVENTION

Heat engines convert thermal energy into useful work using differences in thermal energy between high temperature and low temperature thermal reservoirs. This is accomplished by causing a working fluid, which is typically a gas (but may be, for example, a vapor or supercritical fluid), to perform a thermodynamic cycle.

Such cycles are described by movement through the mathematical space of thermodynamic state variables (state space), resulting in a return to initial state space coordinates at the completion of a cycle. The variables for state space representation most typically used for engine analysis are pressure and volume, which are a pair of conjugate variables, jointly representing units of energy, where one variable is intensive (P) and one is extensive (V).

Accordingly, state space diagrams, which plot the path of cycles in state space, present a geometric method for calculating energy changes in the working fluid throughout the course of a cycle. State space diagrams, by convention and for simplicity in relating to real systems, plot intensive variables on the ordinate axis and extensive variables on the subordinate axis. An example is the Pressure-Volume (P-V) diagram. Integrating the area under each step of the curve on a state space diagram, moving in the appropriate direction, will provide the energy change for that step. In this manner, the magnitude of work invested in fluid compression is subtracted from the magnitude of work spontaneously evolved from fluid expansion, in order to yield the net useful work from the cycle.

When heating and cooling processes are involved in engine operation, it is common to employ regenerative heat exchangers to recover energy released from cooling fluid for use in simultaneous or subsequent heating of the working fluid. Heat regeneration serves to increase the thermal efficiency of a heat engine which, is defined by the ratio of net useful work performed by the engine to the net heat absorbed by the engine.

An example of practical engine embodiment is the Stirling engine. Stirling engines approximate a Stirling cycle, which includes (1) forced isothermal (constant temperature) compression at relatively lower temperatures, (2) isochoric (constant volume) heating, (3) spontaneous isothermal expansion at relatively higher temperatures, and (4) isochoric cooling. On a P-V diagram as depicted in FIG. 5, this is equivalent to moving clockwise from the bottom right of the cycle.

For conventional Stirling engines, the heat absorbed by the engine is a combination of the heat required to maintain the temperature of the gas during isothermal expansion, and the heat required to increase the temperature of the gas. The heat input to the engine for increasing the gas temperature can be reduced by use of a regenerator. Regenerators are a variety of counter-current heat exchanger that use a physical substrate to store heat since working fluid flows only one direction through the regenerator at a time.

The expression for efficiency for Stirling engines, εₜₕ, is described by Equation 1.

$${ɛ}_{th} = \frac{{w}_{E} - {w}_{C}}{{Q}_{E} + ( 1 - {ɛ}_{R} ) {Q}_{V} + {Q}_{L}} . \qquad E 1$$

In this equation (Equation 1), for which all quantities are on a molar basis, W_{E} is the magnitude of the expansion work, W_{C} is the magnitude of the compression work, Q_{E} is the heat absorbed during expansion, ε_{R} is the energy efficiency of thermal energy recovery, Q_{V} is the magnitude of the heat absorbed while the temperature is being increased, and Q_{L} is a term accounting for unrecoverable losses, typically from lost work. In the ideal case, Q_{L} is equal to zero, and Q_{E} is equal to W_{E}.

The ideal Stirling engine converts thermal energy to mechanical energy with isothermal work and contains a working fluid which follows the ideal gas law. Therefore, the magnitude of the work for fluid expansion or compression can be described by the well-known relation of ideal isothermal work (W), expressed by Equation 2, to the molar quantity of fluid (n), the gas constant (R), and the ratio of final volume to initial volume commonly referred to as a compression ratio (C).

|W|=nRT ln(C) E2.

The net work (W_{NET}) performed is the difference between the magnitude of the expansion work at the heat source temperature (T_{H}) and magnitude of the compression work at the heat sink temperature (T_{C}), expressed in Equation 3.

W_{NET}=nRT_{H}ln(C)−nRT_{C}ln(C) E3.

For a theoretical ideal Stirling cycle, the heat absorbed by the working fluid from expansion is equal to the sum of the work performed and the change in internal energy of the fluid during isothermal expansion. The change in internal energy is equal to zero, in the ideal case. The heat absorbed during the isochoric heating step is a direct result of inefficiencies in thermal energy recovery. The total heat absorbed by the working fluid during isochoric heating is proportional to the sum of the total heat capacities of its i components (nᵢc_{i,v}) and the temperature change (dT) experienced. Therefore, the heat absorbed during isochoric heating (Q_{V}) can be written as shown below in Equation 4.

Q_{V}=Σᵢ∫_{T}_{_{C}}^{T}^{_{H}}nᵢC_{i,v}dT E4.

In the ideal limit, Stirling engines approach the currently recognized maximum limit on thermal efficiency for heat engines, known as the Carnot Limit. This limit, which applies to heat engines operating with a constant molar quantity of fluid, a thermal reservoir at a relatively higher temperature, T_{H}, and a thermal reservoir at a relatively lower temperature, T_{C}, can be described mathematically by Equation 5.

$${ɛ}_{max} = 1 - \frac{{T}_{C}}{{T}_{H}} . \qquad E 5$$

In this equation (Equation 5), εₘₐₓ represents the maximum allowed efficiency, T_{H} represents the absolute temperature of the high temperature reservoir, serving as a heat source for the engine and T_{C} represents the absolute temperature of the low temperature reservoir, serving as a heat sink for the engine. Since the Carnot Limit depends only on temperature, the efficiency of conventional engines operating in the same temperature range will depend only on inefficiencies in design.

The present invention has primary application to the enhancement of heat engine efficiency. For practical purposes, the Stirling engine has been long regarded as the most efficient form of conventional heat engine. In the theoretical limit (including ideal heat regeneration), it can theoretically reach the Carnot Limit on engine efficiency.

In practice, there are a wide variety of embodiments of Stirling's engine concept. Kamen, et al. (“Stirling Cycle Machine”, U.S. Pat. No. 8,874,256) teaches a Stirling engine which makes use of two pistons in combination with a special rocking drive mechanism and crankshaft suitable for converting mechanical work into a form where it can drive an electric generator. Johnansson, et al. (“Control Valve for a Stirling Engine”, U.S. Pat. No. 8,534,063) teaches the use of a particular type of control valve within a Stirling device, in order to control leakage between working fluid flowing between control volumes, as well as for pressure balancing. Older prior art by Bland (“Stirling Cycle engine with Catalytic Regenerator”, U.S. Pat. No. 3,871,179—1975) teaches the use of a catalyst within the regenerator of a Stirling engine, in order to increase the number of moles of gas within the engine during heating of the gas, thereby enhancing thermodynamic efficiency and power output of the engine.

When applied to a Stirling cycle device, as one embodiment, the present invention, in contrast to Bland, produces additional moles of gas during the heating of the working fluid, without the use of a catalyst, but instead by incorporation of a working fluid that has a molecular dimer structure that reacts (by a shift in the chemical equilibrium of a reversible reaction) to increased gas temperature by dissociation into monomer gas molecules, in turn creating an additional number of moles of gas at higher temperatures. The dissociation reaction can be either single stage or multi-stage, depending on the operating temperature limits for the engine. Many aspects of the prior art may be retained and used within embodiments of the present invention, for example, the use of multiple pistons, heat regeneration, and control valves. Optimization of embodiments of the present invention must incorporate analysis and consideration of the properties of the chemically reacting working fluid, as well as analysis and consideration of the design issues associated with conventional engines. Additionally, the present invention may be applied to other forms of heat engines, such as particular forms of turbine engines, for example turbines approximating an Ericsson cycle.

### BRIEF SUMMARY OF THE INVENTION

The invention disclosed herein comprises both devices and methods, wherein the specified method is utilized to optimize both the operating points and parameters of the device so that the object advantage is achieved.

The device of the present invention is a heat engine operated with a working fluid comprising chemical components that participate in one or more chemical equilibrium reactions. These reactions create a shift in the equilibrium concentration of the working fluid components according to temperature, resulting in an increased number of fluid particles at higher temperature. As a direct result of the increased molar quantity of working fluid, the device is capable of producing increased useful work from a thermodynamic cycle of the engine. When the device has a means of recovering energy from the shift in equilibrium, which occurs as the temperature is decreased, the present device can operate with increased thermal efficiency, as compared to conventional heat engines of similar design. Possible means of energy recovery may include, for example, heat exchange and/or the net production of useful work. The heat engine may be a piston engine, for example an engine executing a Stirling cycle, or a turbine engine which performs a suitable type of thermodynamic cycle, for example an Ericsson cycle.

In one embodiment, the present invention consists of an engine that executes a Stirling cycle, such engine comprising: one or more cylinders containing a working fluid capable of the required chemical reaction(s), and enclosing piston(s) that can perform work for compression of the working fluid, as well as extraction of useful work from working fluid expansion; a heat exchanger, typically of a counter-current variety, to include regenerators; and two thermal reservoirs, one operated at a higher temperature, corresponding to an operating point where the number of moles of gas has been substantially increased, and one operated at a lower temperature, corresponding to a point where the number of moles of working fluid is substantially less than that at the higher temperature.

For the Stirling engine embodiment, engine operating points and design parameters are chosen via a particular method, elsewhere described in this disclosure, in order to create a net efficiency gain, relative to that of a conventional Stirling engine. Increased efficiency is achieved when the engine is operated with particular concentrations of particular working fluid components, at particular compression ratios, and with select heat source and heat sink temperatures, which depend on the particular details of the selected working fluid components. Additionally, the heat exchanger/regenerator is designed for sufficient recovery, by the regenerative heat exchange process, of the extra energy required for accomplishing chemical reaction of the working fluid, so that a net increase in useful work output and engine efficiency is accomplished at the selected operating points and for the selected engine design parameters.

The method of selecting engine operating points and design parameters is key to achieving the object advantages of the present invention, i.e. an engine device, which has superior efficiency and useful work output as compared to conventional engines that do not utilize gases that undergo equilibrium reactions. The pressure and entropy of the working fluid of the device increase and decrease with temperature, to an extent not realized by conventional engines. The ratio of state and path variable values in the working fluid of the device to the same quantities in the working fluid of conventional engine devices, operating with the same molar concentration at the lowest temperature and pressure of the engine cycle, are subsequently referred to as relative properties, an example being relative entropy, and are considered “high” for values greater than one and “low” for values less than one. The changes in relative pressure and relative entropy are a direct result of temperature dependent changes in the molar quantity of fluid, reversibly accomplished by chemical reaction(s).

High relative pressure in the device at the higher temperature(s) of the cycle directly results in high relative work. Relative pressure is continually increased at the higher temperature(s) of the cycle by pressure dependent reaction during expansion, which results in high relative expansion work. Similarly, relative pressure, initially equal to one, is continually decreased at the lower temperature(s) of the cycle by pressure dependent reaction during compression, which results in low relative compression work. The high relative entropy at the higher temperature(s) of the cycle directly results in higher relative heat absorption, which has a negative effect on thermal efficiency.

The device of the present disclosures can be optimized for thermal efficiency by the method of the present disclosures. This optimization method considerers the lower and higher temperature limits of the engine cycle, the efficiency of thermal energy recovery in the form of work or thermal energy regeneration, the volume or pressure ratio(s) for working fluid expansion and compression, and the molar concentration of fluid components including components used to control chemical reactions. The described method examines mathematically, sources of increased or decreased efficiency as compared to conventional engines, including enthalpy or enthalpies of reaction, irreversible losses from enthalpy or enthalpies of reaction during working fluid expansion, and calculation of work with a variable molar quantity of fluid.

Additionally, the method of the invention considers the impact of recovering thermal energy, including the enthalpy or enthalpies of reaction(s), by use of heat exchangers or useful work production. The described method for optimization also can include consideration of mechanisms for changing the upper and lower temperature operating bounds of the engine cycle in order to increase efficiency and/or power.

The method of the invention requires consideration of both the shift of reaction equilibrium with temperature, as well as reaction kinetics. For example if the rate(s) of chemical reaction(s) are not rapid enough, efficiency gains over conventional engines will not be accomplished. For described embodiments of the device, the described method takes an equilibrium solution approach to the determination of the extents of reaction, since the involved reactions are known to occur with sufficient rapidity, so as to be limited only by heat transfer under normal engine operation.

The method of the invention must deal with the issue of required recovery of invested heat energy using heat exchange/regeneration or net useful work production. A particular embodiment of the device using the Stirling engine architecture, allows for recovery of energy for inducing chemical reaction(s) from the released thermal energy of the cooling fluid by use of a regenerator. It is necessary to achieve high thermal regeneration efficiency (including loss effects from regenerator ineffectiveness and viscous energy dissipation) in order for the device to exceed conventional engine efficiencies, since typical enthalpies of reaction are large, when considering the quantity of net useful work generated from each cycle. The method of the invention allows determination of the required regenerator efficiency so that additional regenerator heat load requirement can be incorporated as a significant design consideration. The required efficiencies necessitate the use of either a larger or an atypical regenerator (such as modified recuperators), to accomplish the same efficiency of thermal energy recovery. The use of atypical regenerator designs is preferable, owing to the loss of swept volume from increased regenerator size. It is also possible to compensate for the larger required size of the regenerator by use of valves, for controlling the flow of working fluid during the expansion and compression steps of the engine cycle.

From the method of the invention it is straightforward to mathematically extend the operating principles of the present device, described in the present disclosure for the Stirling engine embodiment, to include the particular case of an Ericsson turbine embodiment, thus verifying that the heat engine device of the present disclosures may be implemented with turbine components.

While classical turbines operate adiabatically, it has been shown that isothermal work for the Ericsson cycle can be approximated by use of interheaters and intercoolers between adiabatic turbine stages for the “isothermal” expansion and compression steps, respectively.

For the case of a turbine embodiment, the present invention comprises a turbine engine operated with a working fluid comprising chemical components that participate in one or more chemical equilibrium reactions, which occur in response to an increase in working fluid temperature, resulting in an increase of the number of gas particles (moles), typically approximating an Ericsson cycle, further resulting in increased work output from the engine as well as increased engine efficiency, as compared to similar conventional turbine engines that do not use such type of working fluid. Such embodiment additionally incorporates a heat exchanger, typically in the form of a recuperator, for recovery of energy invested for inducing chemical reaction(s), from the released thermal energy of the cooling fluid.

With regard to the utility of the device, the objective is to create an increased ability to generate additional mechanical, electrical, or other forms of power, from thermal energy sources, with higher efficiency than with conventional heat and/or turbine engines. Achieving this objective creates utility for the invention, as this capability increases the utility of available energy resources. The device of the present disclosure is also capable, in particular embodiments, of transforming heat at moderate and low temperatures into useful work, thus providing unique utility for the market in “waste” heat regeneration.

### BRIEF DESCRIPTION OF THE SEVERAL VIEWS OF THE DRAWINGS

The accompanying drawings, which are incorporated into, and form a part of, the specification, illustrate both the physical principles and a representative embodiment of the present invention. When the drawings are combined with the description, they serve to explain the invention so that it can be understood by one with ordinary skill in the art. The drawings are meant only for the purposes of illustration and explanation and are not meant to be construed as limiting the invention. In the drawings:

FIG. 1 presents a representative set of curves which serve to illustrate the dissociation of one particular working fluid, Dinitrogen Tetroxide (N₂O₄), as gas temperature is raised at constant volume. Each curve represents one chemical component involved in the two dissociation reactions. The majority of the first dissociation reaction occurs at relatively lower temperatures and the majority of the second reaction occurs at relatively higher temperatures. The quantity, measured in moles, of each component are shown versus absolute temperature, measured in Kelvins. Note that the first dissociation reaction, occurring at lower temperatures, essentially is complete, (1), before the second reaction occurs, and that at higher temperatures, the molar quantity of NO₂ begins to decrease as it dissociates into NO and O₂.

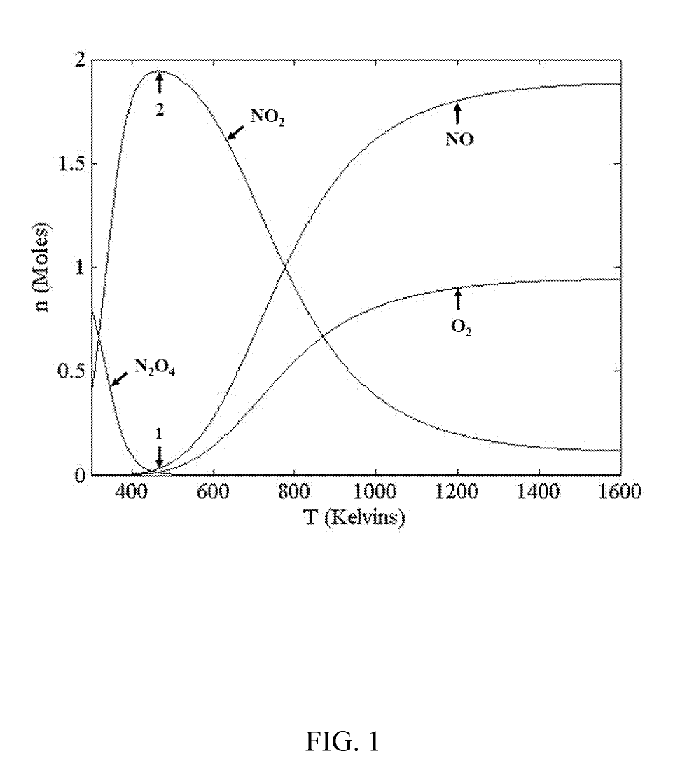

FIG. 2 presents a calculated value for the total quantity, measured in moles, of the above-mentioned working fluid as a function of Kelvin scale temperature, for two different initial concentrations as measured in units of molarity. This figure can be used, for example, to illustrate the effect of compression ratio on the quantity and variation of working fluid molarity versus temperature. Point (1) denotes the curve with the relatively lower initial concentration and point (2) denotes the curve with an initial concentration seven times higher than the molarity of gas used in the curve denoted by point (1). Note that lower initial concentration results in an increased slope of molarity versus temperature in the temperature ranges relevant to chemical reaction. Point (3) demonstrates that at the point where the first stage of chemical dissociation is complete, the dependence of dissociation on initial concentration, and therefore compression ratio, is relatively smaller than at other temperatures.

FIG. 3 is a diagram of the modified operation of a Stirling Cycle for the case of a particular embodiment of the present invention, where the working fluid is chosen to be a gas which dissociates as temperatures is raised. The diagram also illustrates the high temperature and low temperature thermal reservoirs, which are utilized in a conventional heat engine.

FIG. 4 presents one representative embodiment of the present invention which makes use of two cylinders containing movable pistons, regenerative heat exchanger, high and low temperature thermal reservoirs. The heat exchanger (8) shown in the figure is a rotating disk countercurrent exchanger, modified for use in a Stirling engine consisting of twin, synchronized cycles where the two cycles are completely out of phase with each other.

FIG. 5 presents two state-variable cycle curves with the variables chosen as Pressure (P) and Volume (V). In the diagram, the larger area contained within the curve in P-V space bounded by the solid line denoted by point (1), serves to illustrate the larger amount of work generated per cycle with a representative device that embodies the present invention, as compared to the amount of work generated by a conventional Stirling cycle engine that does not use a chemically dissociating gas. The work per cycle of the conventional Stirling engine is equal to the area of the curve bounded by the dotted line, which is seen to be less that the area contained within the solid line curve.

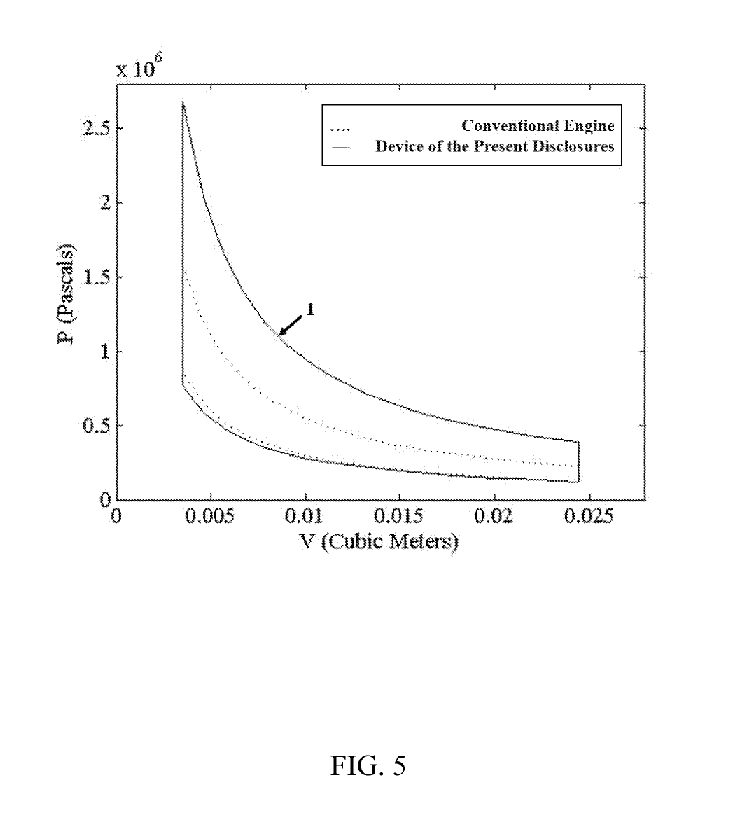

FIG. 6 shows a calculated comparison of estimated absolute engine efficiency in units of percent, for converting heat energy to useful work for both the present invention (solid curve), and the conventional Stirling engine, which does not make use of a dissociating working fluid. The calculation performed was for the one representative embodiment. The comparison serves to illustrate the utility of the present invention in terms of a significant advantage in engine efficiency that results from employment of the principles of the present invention. The comparison is done as a function of Kelvin scale temperature of the high temperature thermal reservoir.

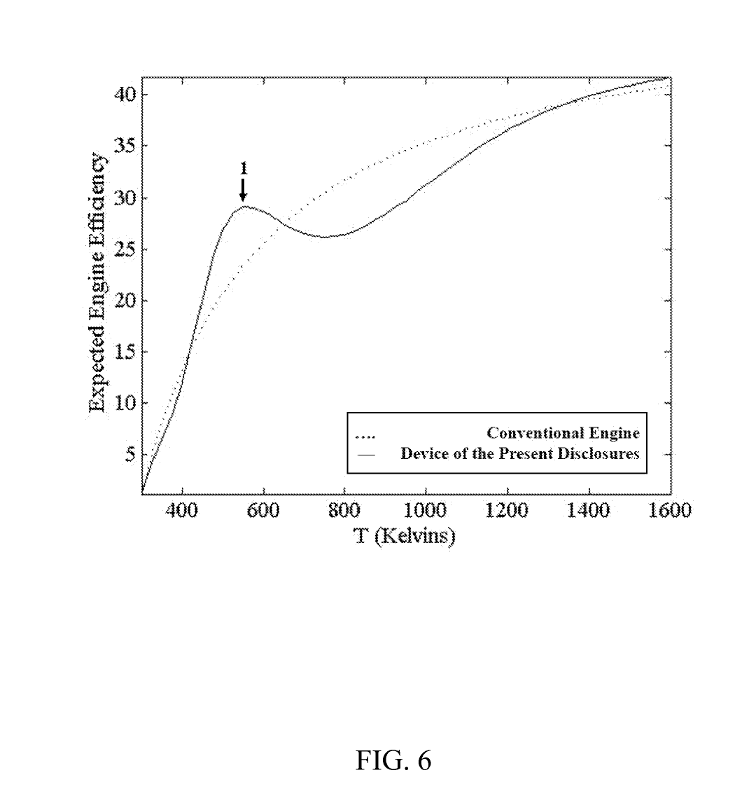

FIG. 7 presents a relative engine efficiency comparison between the present invention, indicated by the solid curve, and that of the conventional Stirling cycle engine, indicated by the dotted curve, as a function of the Kelvin scale temperature of the heat source, for the one particular embodiment. Both sets of data are normalized to the performance of the conventional Stirling engine efficiency. Therefore the conventional engine has a relative performance of unity at all temperatures. This comparison serves to illustrate that the peak advantage of the present invention can be significant. For example, the peak advantage, denoted by point (1), for the representative embodiment is seen to be a 30% improvement relative to a conventional Stirling engine. However, this diagram also serves to illustrate that the device does not produce improvement over the entire temperature range (points (3) and (4)), meaning that a method of optimization, as described within in the specification of the present invention, is required in order to produce a useful improvement in thermal efficiency by selecting operating parameters for the present device. This present figure also serves to demonstrate that there may be multiple temperature ranges where the present device provides an advantage over conventional engines by measure of thermal efficiency. There are two ranges of such advantage in the present figure, denoted by points (1) and (2).

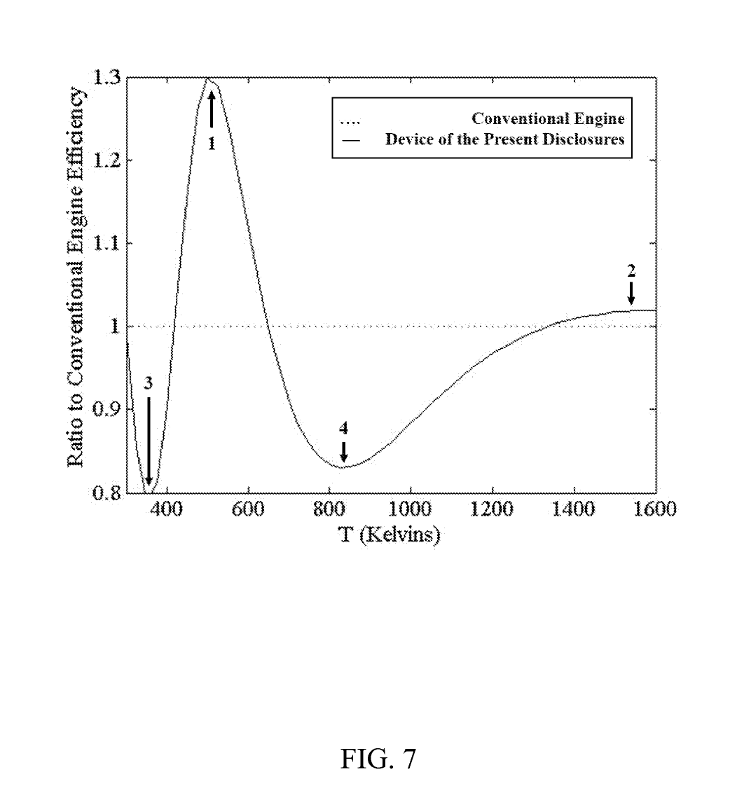

### DETAILED DESCRIPTION OF THE INVENTION

The present disclosures describe a novel heat engine device exploiting a working fluid predisposed to reversible increases in molar fluid quantity, in response to an increase in temperature, by use of one or more chemical reaction(s), to produce additional useful work, with limited additional energy losses, resulting in significantly higher thermal efficiencies compared to conventional engines. Gains in efficiency over conventional engines by the present device are achieved only under select conditions, described by the method of the present disclosures. The present method for optimization considers concentrations of working fluid, compression ratios, and the temperatures of the heat source(s) and heat sink(s). It is found necessary to recover a majority of the energy for accomplishing reaction of the working fluid in order to achieve a gain improvements in efficiency as compared to conventional engines. This can be accomplished by use of regenerative heat exchange or evolved work.

### EXAMPLE EMBODIMENT

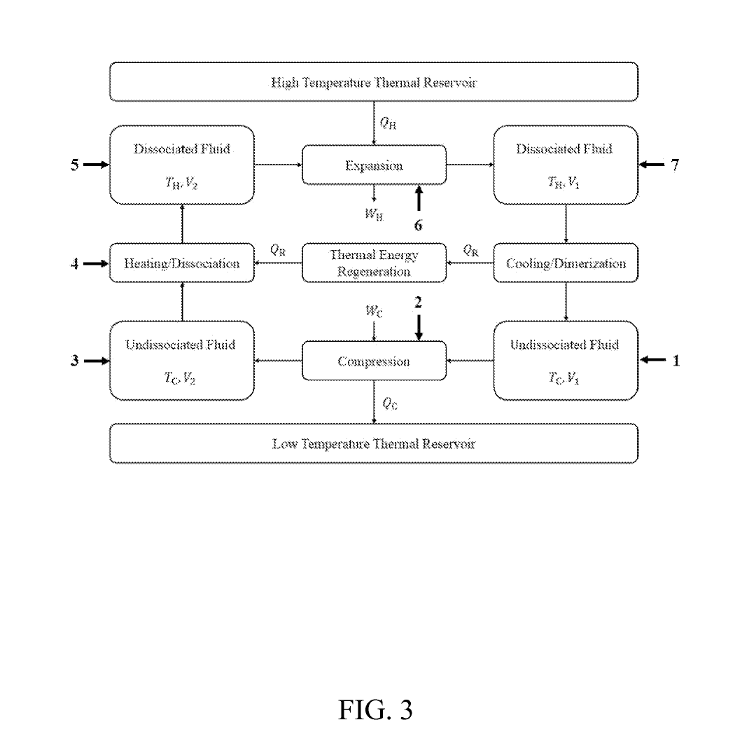

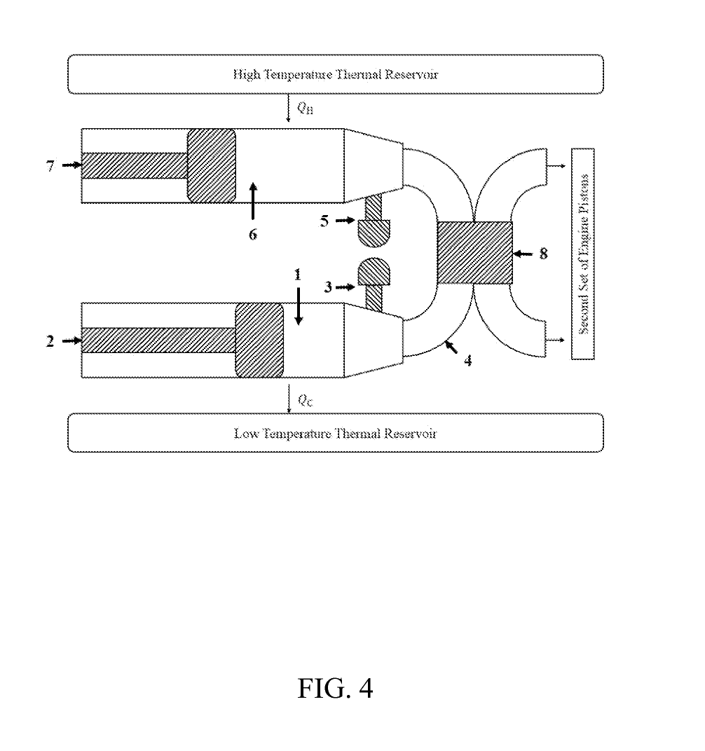

The construction and principles of operation of the present invention are explained herein with reference to one embodiment that is presented in the diagrams of FIG. 3 and FIG. 4. The components of the engine as presented in this embodiment will be familiar to one with knowledge of conventional Stirling cycle engine construction. The selected embodiment described is meant only to illustrate a means of realizing the present invention and is in no way meant to describe all methods by which a device which embodies the invention might be constructed. FIG. 3 presents the thermodynamic stages of operation involved as the device performs a Stirling cycle using a dissociating gas as working fluid. A detailed description of the chosen embodiment requires reference to both FIG. 3 and FIG. 4.

FIG. 4 shows the construction of a two-cylinder embodiment, which may be one module of a larger number of cylinders within an engine. The engine embodiment as shown in FIG. 4 is in part comprised of two cylinders (labeled as 1 and 6 in FIG. 4), each containing the selected working fluid (N₂O₄ for this embodiment), and each having an associated piston and actuator or piston arm (labeled 2 and 7 in the diagram of FIG. 4). During a cycle, one cylinder and piston arrangement performs compression of the gas at low temperature (1), and one extracts work from expansion of gas at high temperature (6). The cold and hot temperatures T_{C} and T_{H} are defined by the temperatures of two thermal reservoirs, as shown in FIG. 4. Other features of the device as shown in FIG. 4, are optional valves, actuated by the engine or flow of the working fluid, (e.g. 3 and 5) for control and direction of the working fluid within the device, tubes for connecting the piston cylinders (4), and a regenerative heat exchanger through which the working fluids from each cylinder exchange heat (8). The hot gas is mostly cooled as it moves from the expansion cylinder through the regenerator to the compression cylinder, while the cool gas is mostly heated as it moves through the regenerator from the compression cylinder to the expansion cylinder. Upon execution of the heating/expansion and cooling/compression operations in each cylinder, respectively, the working fluid from each flows back to the other cylinder through the regenerator, completing the cycle.

The operation of the present engine is step-wise and described thus: Referring to FIG. 4, cold working fluid in the compression cylinder at point (1) is compressed by the piston/arm arrangement (2) while hot working fluid in the expansion cylinder at (6) expands, performing work. Heat (Q_{C} in FIG. 4) is transferred from the compression cylinder during the process to maintain the gas at constant temperature (T_{C}). Thermodynamically, this operation corresponds to the steps in FIG. 3, where the dimerized working fluid (FIG. 3, 1) is cooled and compressed (FIG. 3, 2).

Referring again to FIG. 4, as we continue to describe the operation of the engine, the working fluid next moves through the valve system (3) and into the regenerator (8) where heat exchange takes place. The working fluid then moves through the valve system at (5) into the expansion cylinder (6) where it is heated and allowed to expand within the cylinder against the piston, performing useful mechanical work, which is collected (7).

Thermodynamically, this next series of steps corresponds to the constant-volume (isochoric) heating (point 4 at FIG. 3) and dissociation of the working fluid at (point 5 in FIG. 3), followed by isothermal expansion (point 6 in FIG. 3). The cycle as described above repeats, with gas exchange occurring between the two cylinders occurring at each half-cycle point.

Optimization can be accomplished using a detailed thermodynamic model, to calculate the expansion and compression work, and heat required or produced at each stage of the cycle, inclusive of the thermodynamic effects of chemical reactions. For this reason, a considerable amount of information on the correct modeling of these effects is included herein, as a careful analysis of any particular embodiment of the present invention is required, in order to select appropriate operating points and design parameters for the device.

FIG. 3 and FIG. 4 do not illustrate materials or devices used to control heat flow from the high temperature thermal reservoir of the engine and/or to the low temperature thermal reservoir of the engine, however a particular embodiment may contain this element. Similarly, valves are not necessary and additionally, other mechanisms may be substituted for valves in the control of gas exchange within the cycle.

### Method for Optimizing Device Efficiency Via Operating Point and Design Parameter Selection

The present invention involves a complex interaction of classical engine thermodynamics as well as (potentially complex) reaction equilibrium. For an embodiment of the present invention to successfully achieve efficiency advantage over conventional Stirling cycle engines, a method has been developed to project engine efficiency as a function of the selected working fluid, operating temperature range, and select engine design parameters. This method is described herein.

The relative molar quantity, α, can be expressed by Equation 6, where n₀ is the net quantity of fluid existing previous to progression of reactions (measured in moles). ν is the stoichiometric matrix, with reactions listed in rows and components listed in columns. Components of the stoichiometric matrix are negative for reactants and positive for products. ξ is the extent of reaction vector, with reactions listed in columns. The elements of ξ range from zero, indicating no reaction has occurred, to one, indicating that the reaction is complete. At least one extent of reaction for the described reactions is required to be temperature dependent, resulting in an increase in a with an increase in temperature, within at least one temperature range within the range of temperatures experienced in the present device. The temperature dependence of ξ and α is a direct result of the temperature dependence of the chemical potentials for the components of the working fluid.

$$α = \frac{{n}_{0} + ξ v}{{n}_{0}} . \qquad E 6$$

The molar quantity (n) of a working fluid with temperature-dependent relative molar quantity α is given by Equation 7. The quantity α can be used mathematically the same way for all chemically reactive working fluids, including fluids undergoing a dissociation reaction.

n=αn₀ E7.

An intuitive presentation of the principles of operation for the device is offered by the Stirling engine embodiment, operating with a chemically dissociating gas. For this particular embodiment, both an intuitive analysis and a detailed analysis are disclosed, which form an embodiment of the method presented herein. The intuitive analysis of the present device embodiment is presented first. For this analysis, the ideal theoretical Stirling cycle is considered, operating with an ideal gas.

For the ideal analysis, it is assumed that α is constant during isothermal expansion, since operating conditions can be picked such that pressure driven dissociation changes are small. For example, if all relevant reactions are essentially complete, then there will be no additional reactions, and α will be constant. It is easily seen that the pressure of the gas, expressed by Equation 8, is larger for the described working fluids than for gasses with constant composition.

$$P = α ( \frac{{n}_{0} R T}{V} ) . \qquad E 8$$

Equation 8 can be integrated with respect to volume, by anyone with ordinary mathematical skill, to calculate the ideal work for fluid expansion and compression. The magnitude of the work (W) of the ideal analysis of the present embodiment is described by Equation 9, where T_{H} is the upper temperature limit of the cycle, T_{C} is the lower temperature limit of the cycle, and C is the volumetric compression ratio.

|W|=n₀(αT_{H}−T_{C})ln(C) E9.

It can clearly be seen from Equation 9 that the ideal work for the present embodiment is relatively higher than conventional engines operating with the same initial conditions but without a chemically reactive working fluid. This gain in useful work is a direct result of the increased molar quantity of fluid at the higher temperature reservoir, which multiplies the isothermal expansion work.

The thermal efficiency, εₜₕ, of an ideal cycle Stirling engine operating with a reacting working fluid is given by Equation 10, where ε_{R} is the energy efficiency of heat recovery from the regenerator, in reference to the heating requirements at the high compression isochoric step, and Qᵥ is the molar heat input required for constant volume heating, including all relevant enthalpies of reaction for the working fluid.

$${ɛ}_{th} = \frac{( α {T}_{H} - {T}_{C} ) ln ( C )}{α {T}_{H} ln ( C ) + ( 1 - {ɛ}_{R} ) {Q}_{v} + {Q}_{L}} . \qquad E 10$$

This expression can be simplified to the empirical form given by Equation 11, where β is the effective degree of dissociation, which is a function of the theoretical degree of dissociation and the irreversible losses from reaction during isothermal expansion, and C_{U} is an empirical measure of the efficiency of mechanical and heat exchange components.

$${ɛ}_{th} = {C}_{U} ( 1 - ( \frac{1}{β} ) \frac{{T}_{C}}{{T}_{H}} ) . \qquad E 11$$

Equation 11 is an empirical limit of efficiency, demonstrating the principle of operation for the device of the present disclosures. Note that the inefficiency of the engine is nonlinear with the temperature ratio, unlike conventional engines. For specific cases, a more realistic model can be used.

The present invention incorporates a detailed method for determining feasible, and ultimately optimal, engine design parameters as well as operational parameters according to the selected form of embodiment. This method is described herein. The method incorporates an analysis of chemical reaction thermodynamics and kinetics, as well as engine thermodynamics, calculated in an iterative fashion, to derive performance (efficiency) corresponding to set of parameter choices, with such performance data being further analyzed in order to search over feasible solutions for those that produce an engine design having optimally enhanced efficiency.

There are two stages of chemical dissociation for the gas dinitrogen tetroxide (N₂O₄), given by Equation 12. Both forward reactions for this reversible equilibrium system are endothermic and thus require heat input to proceed.

N₂O₄ [symbol] 2NO₂ [symbol] 2NO+O₂ E12.

It can be seen that, for a one molecule basis, dinitrogen tetroxide dissociates into two molecules of nitrogen dioxide (NO₂) in the first reversible reaction, acting to double the initial molar quantity of fluid. In the second stage, the two molecules of nitrogen dioxide dissociate into two molecules of nitric oxide (NO) and one molecule of oxygen, further multiplying the molar quantity of fluid by 1.5, for a total multiplication factor of 3 as compared to the pre-reaction state. It is found that both described reactions occur with sufficient rate that they are limited under practical circumstances by the rate of heat transfer to and from the working fluid by the various components of the present device.

Heating at constant volume, as opposed to constant pressure, will cause the equilibrium of each reaction stage to tend more towards the reactants in order to resist the increase in pressure created by the increase in the molar quantity of fluid as a result of the reaction, due to Le Chatellier's Principle. Consequently, heating at the high compression limit on volume in the device of the present disclosures will cause a greater shift in equilibrium with temperature in the applicable temperature range for the reaction than cooling at the low compression volume limit. Therefore, unless all stages of reaction are complete at the low compression volume limit and high temperature limit of the Stirling cycle, there will be more heat released during cooling of the gas phase working fluid as compared to the requirements for heating the gas. This effect is beneficial for heat regeneration, as it ensures an excess supply of heat to the regenerator, but implies that unrecoverable thermal energy losses from shifts in reaction equilibrium from pressure changes must occur during isothermal expansion.

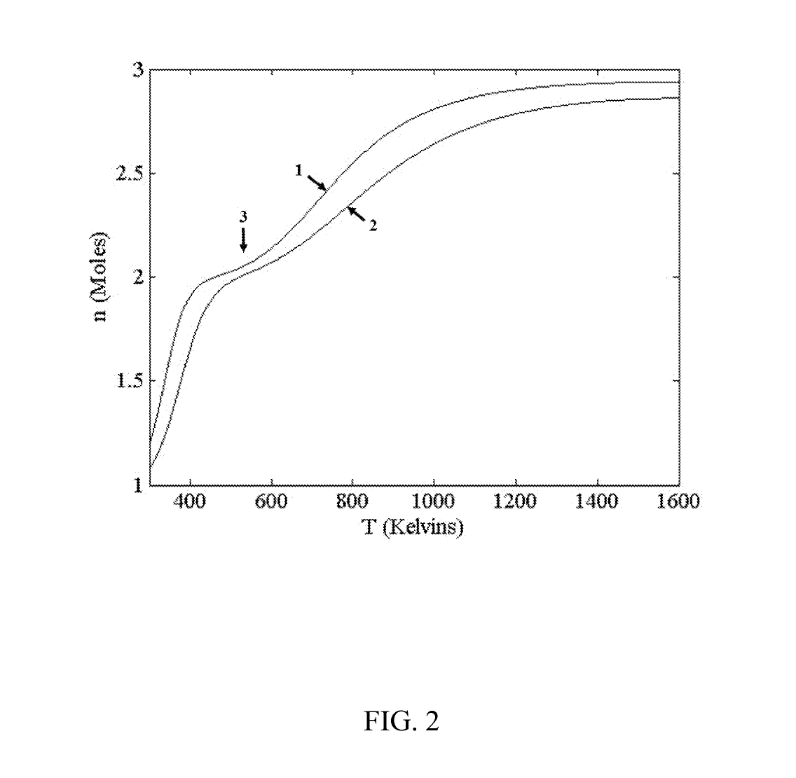

At a typical room temperature and atmospheric pressure (e.g. 293 K and 1 Bar), the first stage of the reaction is partially complete, as suggested by curve 1 of FIG. 2. As a result of this, compression at room temperature will cause the equilibrium of the first reaction stage to shift to the left of the expression, and will therefore cause the pressure to drop relative to a nonreactive gas due to the reduction in molar fluid quantity. If a quantity of the compressed gas mixture is heated at constant volume, the first reaction stage will be nearly complete at approximately 550 K. At higher temperatures, the equilibrium of the second reaction stage is substantially affected.

As a result of the first reaction stage being complete and the second stage having not yet occurred, the local minimum for irreversible losses from reactions driven by temperature and pressure changes occurs approximately at the maximum mole fraction of nitrogen dioxide (approximately 550 K). Irreversible losses from undesired reaction are the primary reason for experiencing a local maximum of efficiency around 550 K, and efficiencies less than that of conventional engines within a higher subsequent temperature range, with the present device embodiment. Irreversible losses from the second reaction stage can be partially mitigated by dilution with oxygen in order to shift the reaction equilibrium to the left of the expression. However, this will also cause a decrease in efficiency gains for a particular upper and lower temperature limit of the engine cycle, due to the reduction in the molar quantity as compared to the molar quantity of fluid at the low temperature, low compression limit. Therefore, there will be an optimum dilution with oxygen to achieve maximal efficiency for a particular set of upper and lower cycle temperature limits. A further region of increased efficiency is achieved only after the second stage of reaction is nearly complete.

Another important design consideration for the present embodiment is the relatively high boiling point for the gas N₂O₄, close to room temperature and atmospheric pressure. As a result, isothermal compression of fluid from STP will cause liquefaction, which is undesired, since vaporization of the liquid N₂O₄ will require additional heat input, and the liquid will make energy recovery with a regenerator much more challenging. Dilution to reduce the partial pressure of N₂O₄ will also reduce relative efficiency gains over conventional engines. Therefore, it is desired to reduce the initial concentration (and thus the pressure) of fluid at the low compression, low temperature input, or to increase the lower bound on temperature, or, preferably, to reduce the compression ratio. While a reduction in fluid concentration will affect work output per cycle, it will have less effect on power generation, since the required heat transfer is also reduced, so the cycle can be implemented at a faster rate. In a practical version of the present embodiment, there will be an optimum tradeoff between the stated design parameters, for reducing liquefaction, that can be calculated or measured by one skilled in the appropriate arts and sciences.

To quantify the analysis of the present embodiment, Stirling cycle can be analyzed by the present method as a combination of nonideal isochoric heat exchange and nonideal isothermal work. Analysis of both types of processes require a solution for chemical equilibrium, an equation of state, and thermochemical property data in addition to selected operating parameters in the form of lower cycle temperature (T_{C}) in Kelvins, upper cycle temperature (T_{H}) in Kelvins, initial fluid concentration (M₀) in moles per cubic meter, and compression ratio (C) as a dimensionless number greater than one.

To calculate equilibrium, it is necessary to minimize the Gibbs free enthalpy for the working fluid system. The contribution to free enthalpy (ΔG_{f,i}⁰) from each component (i) is calculated from the absolute temperature, and entropies (ΔSᵢ⁰) and enthalpies (ΔH_{fi}⁰) of formation, as in Equation 13.

ΔG_{f,i}⁰=ΔH_{f,i}⁰−TΔSᵢ⁰ E13.

The contribution of pressure to the free enthalpy must also be considered. Since the pressure component of the free enthalpy term depends on the extents of reaction, an iterative search method must be used, beginning with a reasonable guess. The iterative search method used by the present embodiment of the disclosed method for optimization is a gradient descent algorithm including the physical constraint of conservation of mass (moles) for each species (nᵢ) by means of Lagrange multipliers (λₖ), where aᵢₖ is the number of atoms of element k in species i. The constraint is given by Equation 14, where Aₖ is given by Equation 15 with n_{0,i} equal to the initial molar quantity of species i.

λₖ(Σᵢaᵢₖnᵢ−Aₖ)=0 E14.

Aₖ=Σᵢaᵢₖn_{0,i} E15.

The reasonable guess for the extent of reaction can be determined by means of an equilibrium coefficient (K_{C}), given by Equation 16 for the first stage of dissociation, where νᵢ is the stoichiometric coefficient for component i. As a very good approximation, Equation 16 has a valid closed form solution close to room temperature and atmospheric pressure.

$${K}_{C} = exp ( \frac{{\sum }_{i} {v}_{i} Δ {G}_{f , i}^{0}}{R T} ) . \qquad E 16$$

The extent of reaction (ξ) for the first stage of reaction depends on the equilibrium constant in this particular case by Equation 17, which can be solved by anyone with ordinary mathematical skill or with a root finder computer program.

(4M₀)ξ²+(K_{C})ξ−K_{C}=0 E17.

The gradient descent algorithm incorporated into the present embodiment of the disclosed method solves Equation 18, with R equal to the commonly known gas constant, Pᵢ equal to the partial pressure of component i, P^{o} equal to the reference pressure for the chemical component thermochemical data (1 Bar in most cases), and φᵢ equal to the fugacity coefficient for each component, calculated based on the equation of state (approximately equal to 1 for most gases).

$$Δ {G}_{f , i}^{o} + R T ln ( ( \frac{{n}_{i}}{{\sum }_{i} {n}_{i}} ) ( \frac{{ϕ}_{i} {\sum }_{i} {P}_{i}}{{P}^{o}} ) ) + {λ}_{k} ( {\sum }_{i} {a}_{i k} {n}_{i} - {A}_{k} ) = 0. \qquad E 18$$

For the analysis of the present device embodiment, the present embodiment of the disclosed method for optimization uses the Peng-Robinson equation of state, which depends on the critical temperature and pressure and acentric factor for each component. The entropies and enthalpies of formation are calculated from data from the National Institutes of Standards and Technology (NIST) WebBook using the Shomate Equation as well as provided data.

The presently embodied method makes use of a Proportional-Integral Controller for the gradient descent algorithm, and an additional constraint on the multidimensional iterative step in molar quantity for each component, so as to maintain the proper reaction mechanism. It should also be noted that a practical engine embodiment will proceed only to the equilibrium defined by the internal temperature and pressure (dependent on compression ratio) of the engine, which may be limited by heat transfer. In the present analysis, a theoretical cycle is considered, where temperature and compression ratio are known.

The presently embodied method uses the method for calculating equilibrium in a simulation, which can be performed to calculate isothermal work (W_{S}) per initial basis mole of working fluid at the low compression, low temperature limit of the cycle. This is accomplished by integrating the partial pressure (Pᵢ) given by an equation of state for each component of the working fluid with respect to volume (Vᵢ), from an initial specific volume (per basis mole at initial conditions) of V₀ to a final specific volume (per basis mole at initial conditions) V_{f} and summing the result, as described by Equation 19.

W_{S}=−Σᵢ∫_{V}_{₀}^{V}^{_{f}}PᵢdVᵢ E19.

The heat absorbed from the high temperature thermal reservoir (W_{S,2}) is the sum of the isothermal work at the high temperature and the change in internal energy, which is a combination of well-known effects of nonideal gases and changes in the chemical potential due to dissociation reactions. The major consideration to the non-work contribution to heat absorption comes from the enthalpy of reaction, for component m, as a result of the dissociation occurring during gas expansion, which can be calculated based on the information given previously. The unrecoverable, specific (per basis mole at low temperature, low pressure limit) contribution to the heat absorption (Q_{L}), from the high temperature thermal reservoir, owing to the enthalpy of reaction, is given by Equation 20. In this equation (Equation 20), ξ_{m,0} represents the extent of reaction before expansion, ξ_{m,f} represents the extent of reaction after expansion, and ν_{m,i} represents the stoichiometric coefficient, in each case for reaction m.

Q_{L}=Σₘ((ξ_{m,f}−ξ_{m,0})(Σᵢν_{m,i}ΔH_{f,i}⁰)) E20.

In a manner similar to Equation 20, the heat absorbed during isochoric heating is given approximately by Equation 21, which includes the contribution of the specific heats of each component. There is some dependence of the internal energy on volume (other than the effect on reactions), but this effect is small for dinitrogen tetroxide and its derivative species. The constant volume specific heats were calculated by the author of the present disclosures using the Shomate equation and theoretical heat capacity ratios with a standard method based on the linearity or nonlinearity of the molecules of each species, and the number of bonds in the same molecule. This equation uses some notation from the background.

Q_{V}={Σᵢ∫_{T}_{_{C}}^{T}^{_{H}}nᵢc_{i,v}dT+Σₘ{(ξ_{m,f}−ξ_{m,0})(Σᵢν_{m,i}ΔH_{f,i}⁰)}} E20.

From the above listed equations, it is possible to derive an equation for the engine efficiency (Equation 21), where W_{S,j} is the work for the Jth (Jε{1,2}) temperature at which expansion or compression is performed, and ε_{R} is a measure of the energy efficiency of heat regeneration, ranging from 0 for no energy recovery from the cooling fluid to 1 for complete regeneration of the quantity of energy required for heating the fluid.

$${ɛ}_{th} = \frac{{\sum }_{J} {W}_{s , J}}{{W}_{S , 2} + ( 1 - {ɛ}_{R} ) {Q}_{V} + {Q}_{L}} . \qquad E 21$$

All of the quantities expressed in Equation 21 are intensive variables and scale with initial molar quantity of fluid, although they do not directly scale with molar concentration of the working fluid, since this affects the chemical equilibrium of involved reactions.

The engine device of the present disclosures has a theoretical efficiency limit that depends not only on temperature, but on the extent of one or more chemical reaction(s). Therefore, it may be advisable under particular circumstances to change the temperature limits of device operation from the temperature limits of the available heat sources and sinks so as to increase efficiency.

The method of the present disclosures provides a means for change the temperature limits of operation for the disclosed device, to increase efficiency, by the use of materials or additional devices, wherein said materials or devices are used to control heat flow from the high temperature thermal reservoir of the engine and/or to the low temperature thermal reservoir of the engine. Such materials or devices serve to control the rate of heat flow to or from the engine, to prevent the establishment of thermal equilibrium by the temperature reservoirs of the engine.

What is claimed is:

1. A heat engine comprising:
a working fluid comprising chemical components that participate in one or more chemical equilibrium reactions
such reaction(s) creating a shift in the equilibrium concentration of the components according to temperature,
the result being an increased number of fluid particles at higher temperature,
with further result being an increased useful work from a thermodynamic cycle of the engine, attributed to the increased number of particles in the fluid,
and additional result being increased thermal efficiency, as compared to conventional heat engines of similar design that do not use such type of fluid,
said device having a means of recovering energy from reversal of said shifts in equilibrium,
such means taking the form of heat exchange and/or the net production of useful work.

2. The device of claim 1, operated with a working fluid comprising chemical components which participate in a chemical dissociation reaction.

3. The device of claim 1, where the heat engine device takes the form of a gas turbine, or includes turbine components.

4. The device of claim 1, where the device takes the form of a Stirling engine, or other engine which approximates a Stirling cycle, containing at least one regenerator and/or other regenerative heat exchanger.

5. The device of claim 1, where said device takes the form of an Ericsson turbine, or other turbine which approximates an Ericsson cycle, containing at least one recuperator and/or other regenerative heat exchanger.

6. The device of claim 1, where the device is used to produce mechanical work or to drive mechanical process.

7. The device of claim 1, where the device is used in combination with an electric generator in order to produce electrical power.

8. The device of claim 1, where said device is used in combination with any number of materials or additional devices, wherein said materials or devices are used to control heat flow from the high temperature thermal reservoir of the engine and/or to the low temperature thermal reservoir of the engine in order to adjust and control the operating point(s) of the engine cycle, thereby further optimizing engine efficiency.

9. The device of claim 1, where said device is used in combination with one or more heat pumps, wherein said heat pump(s) is/are used to control heat flow to the high temperature thermal reservoir of the engine and/or from the low temperature thermal reservoir of the engine in order to adjust and control the operating point(s) of the engine cycle, thereby further optimizing engine efficiency.

10. A method for optimizing the device of claim 1, said method considering the temperature boundaries for the engine cycle, the pressure and/or volume ratios for compression, and the molar concentration of fluid components.

11. The method of claim 10, where the method considers the efficiency of thermal energy recovery.

12. The method of claim 10, where the method considers the addition or removal of a quantities of chemical components to control the equilibrium concentrations of the components of the working fluid.
